(19) United States
(12) Patent Application Publication
(10) Pub. No.: US 2008/0277491 A1
(43) Pub. Date: Nov. 13, 2008

(54) Powder Barrier Coupling for Powder Spray Systems

(75) Inventors: Frank P. Rauch, Wyandotte, MI (US); Eric G. Norrmalm, Brooklin (CA); Charlotte E. Kelly, South Lyon, MI (US); Gunnar Van Der Steur, Chesapeake City, MD (US)

Correspondence Address: GENERAL MOTORS CORPORATION;LEGAL STAFF, MAIL CODE 482-C23-B21, P O BOX 300, DETROIT, MI, 48265-3000, US

(73) Assignees: GM GLOBAL TECHNOLOGY OPERATIONS, INC., DETROIT, MI (US); EFC SYSTEMS INC., HAVRE DE GRACE, MD (US)

(21) Appl. No.: 11/745,012

(22) Filed: May 7, 2007

(51) Int. Cl. B05B 1/12

(52) U.S. Cl. 239/11; 239/569; 239/654

(57) ABSTRACT

A powder barrier coupling for a pneumatic line of a powder spray system which is air passable but powder impassable. An exterior shell forms a passage. Disposed sealingly within the passage is a porous filter media having an average pore size and thickness which are predetermined to permit passage therethrough of air, but prevent the passage therethrough of powder of a selected average cross-sectional size.

### TECHNICAL FIELD

The present invention relates to powder spray systems, and more particularly to a barrier of the pneumatic control lines thereof which permits passage therethrough of air, but prevents the passage therethrough of powder.

### BACKGROUND OF THE INVENTION

Electrostatic spray applicators are widely used in the coating industry for powder spray coating of substrates such as automotive vehicles. Spray gun applicators mounted on programmable robots used in automated production lines are advantageous in applying uniform coatings of powder to irregularly-shaped substrates.

FIG. 1 schematically depicts a conventional powder spray system 1. A substrate 2 to be powder coated passes an applicator assembly 3. A feed hopper 4 holds a powder 5 in a fluidized state via entry of compressed air through pneumatic line A1 (fluidizing air) into the bottom of the feed hopper. A powder pump 6, for example operating on a venturi principle using a secondary compressed air pneumatic line A2 (powder supply air), and an additional compressed air pneumatic line A3 (atomizing air), delivers the fluidized powder line PL to an optional color changer which is interfaced with other feed hoppers containing differing powders, wherein the hopper selection at the color changer is determined by a pneumatic changer control line 10 from a pneumatic controller 8. The fluidized powder is delivered from the color changer to the applicator assembly 3 via a continuation of the fluidized powder line PL, wherein the compressed air is regulated by the pneumatic controller 8. The powder particles are electrically charged negative at the applicator assembly via a high voltage cable VC which is interconnected with a voltage source 9 located at the pneumatic controller. A pneumatic control line 7 from the pneumatic controller controls the spraying operation of the applicator assembly, whereby the sprayed ionized powder P⁻ is attracted to the substrate because the substrate is electrically grounded. This electrical attraction of the powder to the substrate provides an evenly distributed coating upon the substrate, which is retained sufficiently long until the coating is affixed. After powder coating, the powder coated substrate is placed in a bake oven, wherein the elevated temperature melts the powder to affix the coating on the substrate in the form of a durable finish. A pneumatic purge line 11 is utilized by the pneumatic controller to powder purge the applicator assembly.

Spray gun applicators, which are generally used to spray a powder coat on a more narrowly defined and irregular surface, are normally affixed through a wrist component to the end of a robot arm, and dual spray-head guns for such applications are known. See, for example, U.S. Pat. No. 5,320,283. Control valves are provided which control the flow of powder supplied to the spray gun applicator, on command. The control valves may be controlled electrically or pneumatically, most preferably pneumatic pinch valves.

FIG. 2 shows a schematic perspective view, and FIG. 3 shows a sectional view, of a prior art powder spray applicator assembly 50, as generally described in U.S. Pat. No. 6,817,553 B2, which patent is hereby incorporated herein by reference, and wherein the disclosure thereof is generally discussed hereinbelow merely by way of an exemplification of a known powder spray system. In operation, a spray coating is applied to a substrate 19 using either a rotary bell cup applicator head 14 with spray deflector 17 (see FIG. 3) or a spray gun nozzle applicator 12 (see FIG. 2) affixed to a universal wrist receptacle 13 by means of a connector 15.

The coating powder 20 is applied as a fine spray as the substrate 19 passes in proximity to the selected applicator 12, 14. As the substrate 19 passes the applicator, the electrically charged powder particles, discharged in mist-like form, are attracted to the electrically grounded substrate 19 to provide an evenly distributed coating on the substrate 19. The powder 20 is supplied to the applicator through powder supply line 38 and is fed into, and through, an arm 29 and a robotic arm extension assembly 22, to which is affixed the wrist receptacle 13 via a sleeve connector 21. The movement in space of the wrist receptacle 13 is controlled robotically in three dimensions by means of the pivoting housing mechanism 26 and pivot 27 (up and down), connected thereto by a quick disconnect connector sleeve 24 which is, in adjacent connection, affixed to a base connector 28, rotatable in space by means of a rotating joint 30 affixed thereto by an extension joint 31. The robot arm 34 is also axially movable and controllable in space in a direction along the central axis of the arm. An air line 36 supplies air to power the turbine of the bell cup applicator head 14, an electric line 42 supplies the electric power for charging the powder particles, and pneumatic control lines 40 and 41 provide pneumatic power for switching of the pneumatic pinch valves 72, 82 used to control the flow of powder to one or the other of the applicator heads 12, 14.

FIG. 3 shows, in greater detail, the wrist receptacle 13 affixed to the end of the robotic arm extension assembly 22 by the screw threaded sleeve connector 21. Removably inserted into the wrist receptacle 13 is the spray gun applicator 12. Pin 25, mounted on the robotic arm extension assembly 22 and fitting into a bore in the wrist receptacle 13, keeps the powder supply channels 52, 53 in mutual registry at all times. Powder flow to and through the applicator 12 from the powder supply channel 52 is controlled by the pneumatic pinch valve 82, described in detail below, shown in the “closed” state by pressure applied thereto via the pneumatic control line 40. The spray gun applicator 12 is held in place in the wrist receptacle 13 by the connector 15 via a threaded connection, the threads not shown.

Shown integral with the wrist receptacle 13 is the turbine driven bell cup rotary spray applicator assembly, including the turbine 56 driven by turbine blades 62 and rotating within the cavity shown in the wrist receptacle 13. The air/powder mixture supplied through the powder supply channel 52 is fed into the rotating turbine 56 and impinges on the rotating deflector 58. The turbine body is housed within the wrist receptacle 13 and the air-powder mixture passes therethrough to the bell cup assembly mounted at the forward end thereof, maintained at a high voltage. The powder passing axially through the turbine housing 56 impinges on the deflector 58, at which point it is redirected radially outwardly therefrom, as indicated by the arrows, forming the aforesaid powder mist used to coat various substrates.

A coaxial discharge nozzle 57 extends through the pneumatically powered turbine 56 and provides a passageway for the air-powder mixture. The coaxial discharge nozzle 57 runs centrally through, but not connected to, the rotating turbine 56. Affixed to, and in cooperative alignment with, the end of the turbine is the smaller diameter end of the bell cup. Spaced apart from the bell cup is the deflector 58, the bell cup and deflector together forming the annular passageway tapering out to the periphery. The air-powder mixture is dispensed onto the interior surfaces of the bell cup, which is rotated by the turbine, and travels by centrifugal forces out the gap in the periphery of the bell cup and out into the atmosphere. The front faceplate 17 of the bell cup is electrically conductive and connected to an ionizing source, housed elsewhere in the system, and houses the emitting electrode 60 extending externally from the axial center of the bell cup. The emitting electrode 60 (also 70) is charged by the ionizing source, and creates an ionized field into which the powder particles, having exited the bell cup and into the atmosphere, enter and become charged. The ionized powder particles are thence attracted to the electrically charged (grounded) substrate to provide an evenly distributed coating on the substrate. The powder particles may be further influenced toward the grounded substrate by means of compressed air (referred to as “shaping air”), not shown, that flows from an externally supplied source through passages in the system and the module, to a cavity that is created by the bell cup applicator head 14 that covers and encompasses the pneumatic turbine, which at one end mates against an inner shroud 66 that is connected to and is coaxial with the pneumatic turbine. The mating surface between the inner shroud and the outer shroud is an angular diameter surface that seals the internal cavity between the outer shroud, inner shroud, and the module. The shaping air pressurizes this cavity and impinges on the ionized powder particles and forces it forward of the rotary atomizer, parallel to its axis, and toward the substrate being coated. Powder flow into the turbine bell cup applicator from the powder supply channel 52 is controlled by the pneumatic pinch valve 72, described in detail below, shown in the “open” state via release of pressure in the pneumatic control line 41, thereby directing all of the powder to and through the bell cup applicator. The powder supply line 3 8, electrical supply lines 42, turbine air supply 36 and pneumatic control air lines 40 and 41 are all included for completeness, as are the electrical cascade 44 and electrical connectors 46, all shown schematically and eliminating detail.

The pneumatically operated membrane pinch valves 72 and 82 are depicted in cross-section in FIGS. 4 and 5. In the system shown in FIGS. 2 and 3, two applicator ports 54 and 55 extend from the distal end of the powder supply port 53 for discharging an air-powder mixture to a selected one of the two applicators 12, 14. The two ionized applicator ports are separated some distance from each other in order to allow each applicator port to be used separately, one port discharging, by means of an attached applicator, the air-powder mixture while the other port is closed. Powder flow through the two ports is controlled by the tube shaped pneumatic pinch valves 72, 82 having flexible membranes 72′, 82′ with flared flange ends 74, 84. These membranes can be made of a material having elastomeric properties that constrict the tubes under a pneumatic force. Each membrane 72′, 82′ has an associated cylindrical collar 80, 90, having undercuts 78, 88 encasing its outside diameter between the membrane's flared ends. These collars preferably have a series of intersecting holes 75, 85 around their circumferences and midway along their lengths. The membranes, along with the attending collars, fit into the cylindrical coaxial cavities 54′, 55′ in the powder supply tubes 54, 55, wherein the powder supply tubes and the pneumatic pinch valves (when open as shown at FIG. 4) have equal inner diameters. The cavity into which each membrane 72′, 82′ and its associated collar 80, 90 are housed is pneumatically sealed by the flared ends 74, 84. The undercuts 78, 88 are externally connected, via inlets 76, 86, to the pneumatic control lines 40, 41 through which compressed air of sufficient pressure may flow that causes the membrane to deform and constrict toward its center axis to the extent that the internal diameter of the membrane is closed off to the flow of the air-powder mixture therethrough, as shown at FIG. 5. The intersecting pneumatic control line 40, 41 is connected to a source of compressed air and runs through a pneumatic solenoid switch that turns the supply of compressed air on and off on command of the pneumatic controller. In this regard, FIG. 4 shows pneumatic pinch valve 72 positioned in powder supply channel 54 in the “open” state due to an absence of applied pneumatic pressure, whereas FIG. 5 shows pneumatic pinch valve 82 positioned in powder supply channel 55 in the “closed” state, under the force of applied compressed air as indicated by the arrows.

During the operational lifetime of a powder spray system, the pneumatic pinch valves are cycled through many pinching actions, which eventually adversely affects the resiliency and sealing capability of the membrane of the valve. In the event the membrane sealing fails to be complete, it is possible for powder to migrate along the pneumatic control lines back to the pneumatic controller. In that the air control of the pneumatic controller is effected by solenoid valves, the migration of the powder can adversely affect these solenoid valves, and even migrate outside these valves. In such an untoward operational situation, the powder can then disperse anywhere in the pneumatic controller and the high voltage supply, causing a magnified maintenance problem that is far beyond the scope of the original problem, which was the simple replacement of the faulty membrane.

Additionally, powder can contaminate any of the other pneumatic lines, as for example the purge line, the color changer control line, and the applicator control line, whereby the powder could migrate back to the pneumatic controller and cause deleterious effects thereat.

Accordingly, what is needed in the art of powder spray systems is an ability to prevent powder migration in the pneumatic lines.

### SUMMARY OF THE INVENTION

The present invention is a powder barrier coupling for a pneumatic line of a powder spray system, wherein the powder barrier coupling is air passable but powder impassable, serving to prevent powder migration in the pneumatic line back to the pneumatic controller.

The powder barrier coupling according to the present invention has an exterior shell, preferably cylindrical, forming an interior passage between a first end and an opposite second end. Disposed sealingly within the passage is a porous filter media having an average pore size which is predetermined to permit passage therethrough of air, but prevents the passage therethrough of powder of a selected average cross-sectional size per a preselected thickness which is sufficient to ensure that powder will be entrapped by the porous filter media.

In operation of the powder barrier coupling according to the present invention in conjunction with a powder spray system, a powder barrier coupling is installed, respectively, into each pneumatic line interfaced with the pneumatic controller, wherein the porous filter media has an average pore size and thickness predetermined to entrap powder having a known average cross-sectional size and thereby prevent the powder from entering into the pneumatic controller. The connection of the first and second ends of the shell of the powder barrier coupling can be by any suitable sealing connection, preferably via conventional push-lock fittings.

Accordingly, it is an object of the present invention to provide a powder barrier coupling for the pneumatic lines of a powder spray system to prevent powder migration in the pneumatic line from entering into the pneumatic controller.

This and additional objects, features and advantages of the present invention will become clearer from the following specification of a preferred embodiment.

### BRIEF DESCRIPTION OF THE DRAWINGS

FIG. 1 is a part sectional schematic side view of a prior art powder spray system.

FIG. 2 is a perspective view of a prior art powder spray applicator assembly.

FIG. 3 is a sectional view of the prior art powder spray applicator assembly of FIG. 2.

FIG. 4 is a sectional view of a prior art pneumatic pinch valve, shown operationally in the open configuration.

FIG. 5 is a sectional view of the prior art pneumatic pinch valve, shown operationally in the closed configuration.

FIG. 6 is a sectional view of the powder barrier coupling according to the present invention.

FIG. 7 is a sectional view, seen along line 7-7 of FIG. 6. FIG. 8 is a sectional view, seen along line 8-8 of FIG. 6.

FIG. 9 is a sectional view of the powder barrier coupling of FIG. 6, now shown operationally connected to a pneumatic control line of a pneumatic pinch valve in which powder is present in the line between the valve and the coupling.

FIG. 10A is a block diagram of a powder spray system incorporating the powder barrier coupling according to the present invention.

FIG. 10B is a part sectional schematic side view of a powder spray system (as per FIG. 1), wherein now a powder barrier coupling of FIG. 6 is installed at each pneumatic line interfaced with the pneumatic controller.

### DESCRIPTION OF THE PREFERRED EMBODIMENT

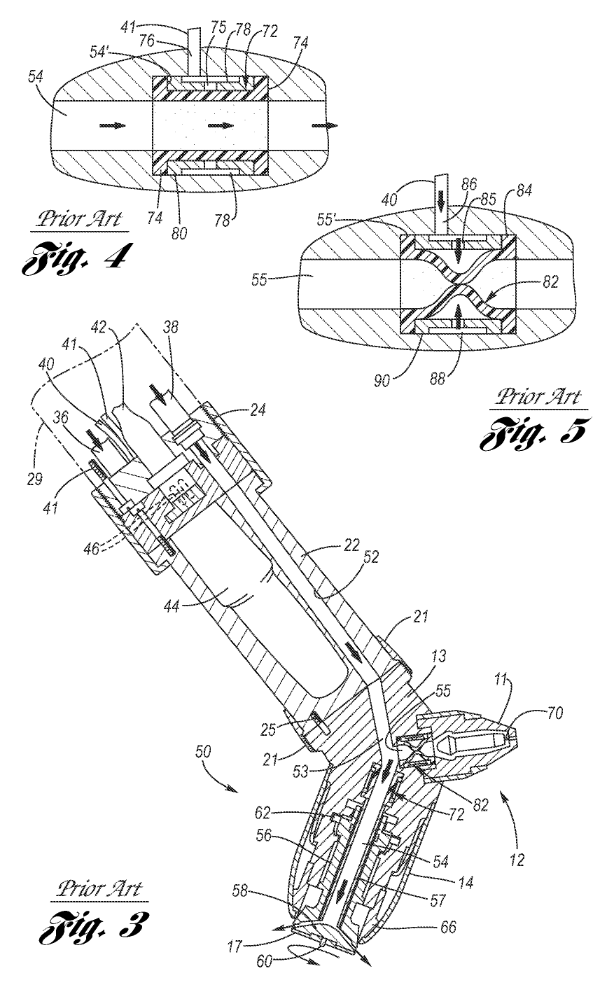

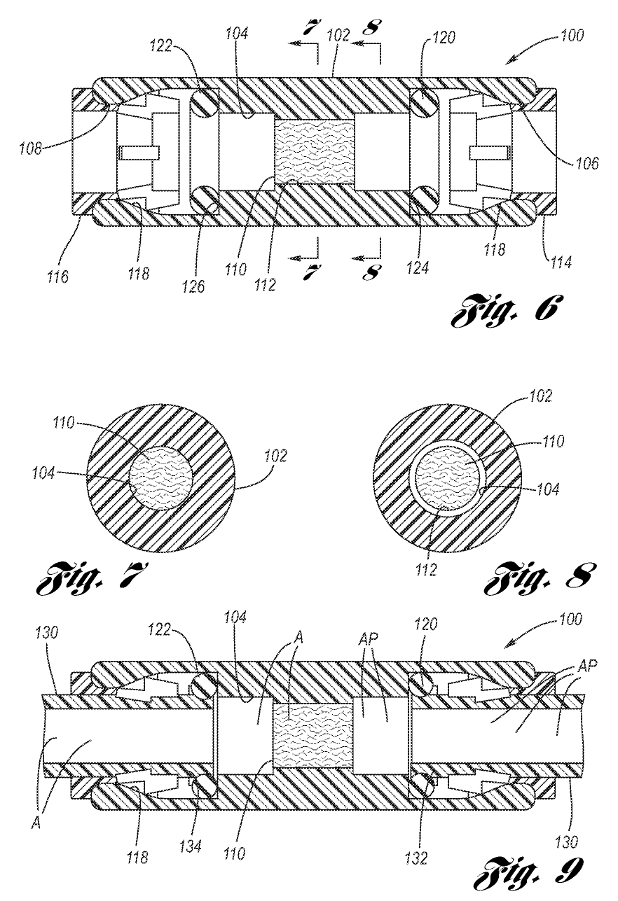

Referring now to the Drawing, FIGS. 6 through 10B depict an example of a powder barrier coupling 100 for a pneumatic line of a powder spray system, wherein the powder barrier coupling is air passable but powder impassable, serving to prevent powder in the powder spray system from migrating along the pneumatic line back to the pneumatic controller, particularly for a non-limiting example, the pneumatic pinch valve control lines (see lines 40 and 41 in FIGS. 2 and 3) in the event there is a seal failure of the membranes of pneumatic pinch valves (see particularly, in this regard, FIGS. 4 and 5).

As shown at FIGS. 6 through 8, the powder barrier coupling 100 has an exterior shell 102, preferably of a cylindrically shaped plastic, forming an interior passage 104 between a first end 106 and an opposite second end 108.

Disposed within the passage is a porous filter media 110 having an average pore size which is predetermined to permit passage therethrough of air, but inhibits the passage therethrough of powder of a selected average cross-sectional size, and wherein the porous filter media has a thickness which is sufficient to ensure that powder will be entrapped. A preferred porous media is POREX™ sheet of Interstate Specialty Products of Sutton, Mass. 01590, which is a polyethylene material. In order to mount the porous media filter 110 in a stable, sealing manner with respect to the passage 104, a reduced diameter filter retention shoulder 112 is provided which compressibly affixes the porous filter media thereat.

In that the preferred interconnection of the first and second ends 104, 106, is via conventional push-lock fittings (retainers) 114, 116, the interior passage 104 has a taper 118 adjacent each of the ends in order to retainingly receive the push-lock fittings in a conventional manner. The preferred push-lock fittings (retainers) are manufactured by EFC Systems, Inc. of Havre de Grace, Md. 21078. O-rings 120, 122 are located in the passage 104 on either side of the retention shoulder 112 in adjoining relation to a respective abutment 124, 126, located between the retention shoulder and the tapers 118.

The taper 118, the O-rings 120, 122 and the push-lock fittings 114, 116 are collectively all well known in the prior art for providing a sealing affixment of a hose with respect to a coupling. See, for example, FIGS. 18-20 of U.S. Pat. No. 6,619,563 B2.

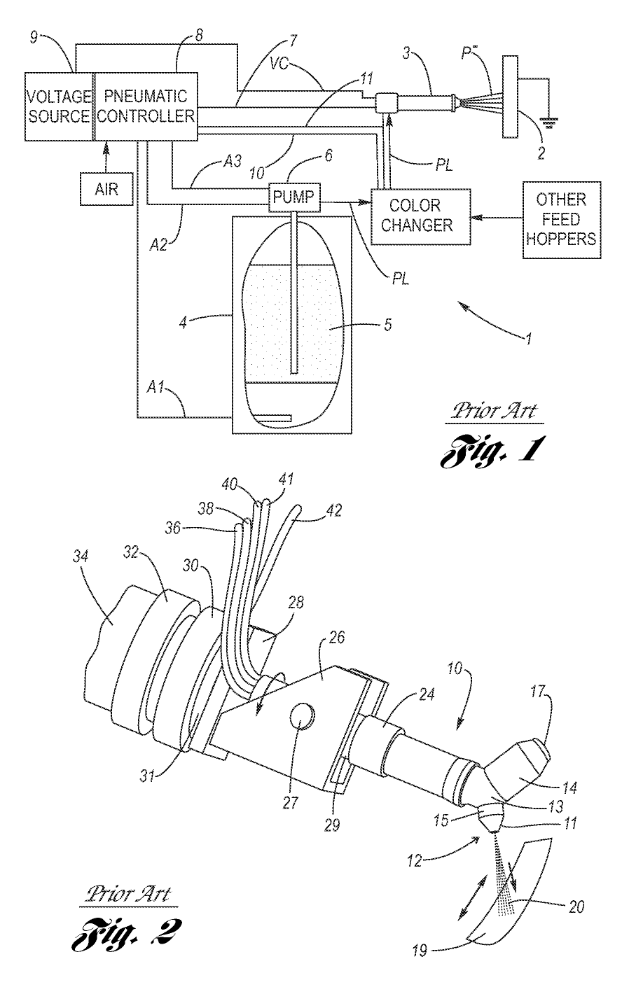

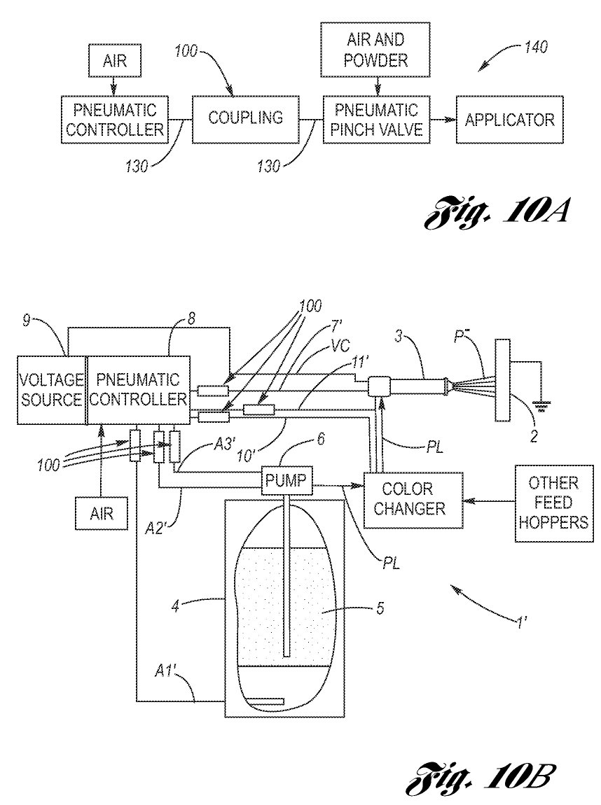

Referring now to FIGS. 9 through 10B, operation of the powder barrier coupling 100 will be detailed with respect to a powder spray system 140, as for example discussed hereinabove with respect to FIGS. 1 through 5.

Firstly, with regard to FIGS. 9 and 10A, the powder barrier coupling 100 is installed, respectively, into each pneumatic control line 130 used for regulating the operation of a pneumatic pinch valve of the powder spray system, wherein the powder being used has an average cross-sectional size which is related to the average pore size and thickness of the porous filter media 110 such that the porous filter media is a barrier to the powder but not to the passage therethrough of air. The pneumatic pinch valve control line 130 is a hose which is cut and interfaced at each end by a push-lock fitting 114, 116. When the push-lock fittings are inserted into the respective first and second ends 106, 108, the ends 132, 134 of the hose 130 about sealingly a respective O-ring 124, 126.

By way of example, the powder used in the powder spray system has an average cross-sectional size of between 22 and 30 microns. The porous filter media 110 has a pore size of between 15 and 45 microns and a thickness T of 0.25 inches, as for example POREX™ sheet item identification POR-4902. As depicted at FIG. 9, the associated pneumatic pinch valve seal has failed and the powder is contaminating the air, creating a powder contaminated air AP in the pneumatic control line 130 between the pneumatic pinch valve and the powder barrier coupling 100. However, the porous filter media 110 successfully acts as a barrier to the powder, while simultaneously permitting the air A to pass therethrough, whereby powder contamination of the pneumatic controller is avoided.

Referring next to FIG. 10B, a powder spray system 1′ is shown having components identical to the powder spray system 1 of FIG. 1 with same part identifiers, or having modified components with the same part identifier but with a prime. In this regard, the powder system 1′ is a modified powder spray system of FIG. 1 in that now the pneumatic lines A1′, A2′, A3′, 7′, 10′ and 11′ are all provided with the powder barrier coupling 100 of FIG. 6 so that powder cannot migrate back to the pneumatic controller 8.

To those skilled in the art to which this invention appertains, the above described preferred embodiment may be subject to change or modification. Such change or modification can be carried out without departing from the scope of the invention, which is intended to be limited only by the scope of the appended claims.

1. In a powder spray system comprising a pneumatic controller, a source of compressed air, a fluidized powder selectively movable by the compressed air, and at least one pneumatic line interfaced with the pneumatic controller;
wherein an improvement thereto comprises a powder barrier coupling connected to at least one selected pneumatic line interfaced with the pneumatic controller, said powder barrier coupling comprising:
an exterior shell defining an interior passage, a first end and an opposite second end;
a porous filter media sealingly disposed in said passage, wherein said porous media has a pore size and thickness which are predetermined to provide a barrier to the powder, yet allow passage therethrough of air; and
means for connecting said first and second ends to the selected pneumatic line;
wherein said powder barrier coupling prevents powder migration along the selected pneumatic line to the pneumatic controller.

2. The powder spray system of claim 1, wherein the selected pneumatic line is a pneumatic control line of a pneumatic pinch valve.

3. The powder spray system of claim 1, wherein the selected pneumatic line is a color changer pneumatic control line of a color changer.

4. The powder spray system of claim 1, wherein the selected pneumatic line is a pneumatic purge air line.

5. The powder spray system of claim 1, wherein the selected pneumatic line is a pneumatic applicator control line.

6. The powder spray system of claim 1, wherein said at least one selected pneumatic line comprises a plurality of selected pneumatic lines, each selected pneumatic line having a respective said powder barrier coupling connected thereto.

7. The powder spray system of claim 6, wherein the plurality of selected pneumatic lines is selected from the group consisting of: a pneumatic control line of a pneumatic pinch valve; a color changer pneumatic control line of a color changer; a pneumatic purge air line; and a pneumatic applicator control line.

8. A powder barrier coupling for a pneumatic line, comprising:
an exterior shell defining an interior passage, a first end and an opposite second end;
a porous filter media sealingly disposed in said passage, wherein said porous media has a pore size and thickness which are predetermined to provide a barrier to a powder having a predetermined average cross-sectional size, yet allow passage therethrough of air; and
means for connecting each of said first and second ends to a pneumatic line such that the pneumatic line is sealed with respect to said passage;
wherein said means comprises:
a push-lock fitting respectively interfaced at each of said first and second ends; and
an O-ring seal located adjacent, respectively, each push-lock fitting;
wherein each push-lock fitting is configured to receive the pneumatic line such that the pneumatic line is sealed with respect to said passage by a respective O-ring seal.

9. A method for controlling operation of a pneumatic pinch valve of a powder spray system, comprising the steps of:
providing a source of pinch valve control air;
delivering the pinch valve control air to a pneumatic pinch valve via a pneumatic control line, wherein selected pressure of the pinch valve control air causes a membrane of the pneumatic pinch valve to switch between an open state and a closed state; and
preventing powder of the powder spray system from migrating from the pneumatic pinch valve via the pneumatic control line to the source by inserting a powder barrier coupling between the pneumatic pinch valve and the pneumatic control line.
